(19) United States
(12) Patent Application Publication
(10) Pub. No.: US 2016/0141698 A1
(43) Pub. Date: May 19, 2016

(54) REDOX FLOW BATTERY

(71) Applicant: NISSIN ELECTRIC CO., LTD., Kyoto (JP)

(72) Inventors: Lan HUANG, Kyoto (JP); Hiroshige DEGUCHI, Kyoto (JP); Masaru YAMAUCHI, Kyoto (JP); Shosuke YAMANOUCHI, Kyoto (JP)

(73) Assignee: NISSIN ELECTRIC CO., LTD., Kyoto (JP)

(21) Appl. No.: 14/901,072

(22) PCT Filed: Jun. 9, 2014
(86) PCT No.: PCT/JP2014/065233

§ 371 Date: Dec. 28, 2015

(30) Foreign Application Priority Data
Jun. 28, 2013 (JP) PCT/JP2013/067890

(51) Int. Cl. H01M 8/18; H01M 8/04082; H01M 8/20

(52) U.S. Cl. CPC H01M 8/188; H01M 8/20; H01M 8/04201; H01M 2300/002

(57) ABSTRACT

A redox flow battery includes a charge/discharge cell (11), a first tank (23) for storing a positive-electrode electrolyte (22), and a second tank (33) for storing a negative-electrode electrolyte (32). The positive-electrode electrolyte (22) contains, for example, an iron redox-based substance and citric acid. The negative-electrode electrolyte (32) contains, for example, a titanium redox substance and citric acid. The amount of dissolved oxygen in the negative-electrode electrolyte (32) in the second tank (33) is no greater than 1.5 mg/L.

### BACKGROUND OF THE INVENTION

1. Field of the Invention

The invention relates to a redox flow battery.

2. Description of Related Art

Generally, a strongly acidic electrolyte is used in a redox flow battery. As an example of the strongly acidic electrolyte, an electrolyte that contains a vanadium redox-based substance has been put into practical use. The metal redox ions in the strongly acidic electrolyte are dissolved stably even at a relatively high concentration and therefore can increase the energy density of the battery. Moreover, in the strongly acidic electrolyte, the carriers of ion conduction are H⁺ ions or OH⁻ ions. Because the mobility of H⁺ ions and the mobility of OH⁻ ions are both relatively high, the strongly acidic electrolyte has high conductivity. Thus, the resistance of the battery decreases, and as a result the efficiency of the battery is enhanced. However, the material that constitutes the redox flow battery is required to have chemical resistance that can withstand the strongly acidic electrolyte.

Meanwhile, Patent Literatures 1 and 2 have disclosed weakly acidic electrolytes. Patent Literature 1 has disclosed a negative-electrode electrolyte that contains an iron redox-based substance and citric acid. Patent Literature 2 has disclosed a negative-electrode electrolyte that contains a titanium redox-based substance and citric acid. Patent Literatures 1 and 2 have disclosed figures that show the relationship between the pH and potential of the negative-electrode electrolyte. In the case of using the weakly acidic electrolyte, as compared with a strongly acidic electrolyte, the requirement for the chemical resistance of the material that constitutes the redox flow battery is lowered.

In order to suppress reaction between the electrolyte used in the redox flow battery and oxygen, an electrolyte tank having a structure for replacing air with nitrogen has been proposed (see Patent Literatures 3 and 4).

### PRIOR ART LITERATURE

### Patent Literature

Patent Literature 1: Japanese Patent Publication No. S56-42970
Patent Literature 2: Japanese Patent Publication No. S57-9072
Patent Literature 3: Japanese Patent Publication No. 2002-175825
Patent Literature 4: Japanese Patent Publication No. S62-15770

### SUMMARY OF THE INVENTION

### Problems to be Solved by the Invention

As described above, for the redox flow battery that uses the weakly acidic electrolyte, the requirement for the chemical resistance of the material that constitutes the battery is lowered. Therefore, it is possible to avoid using expensive materials. Accordingly, it is advantageous in reducing the equipment costs.

In addition, the weakly acidic electrolyte is composed of iron, titanium, and citric acid, which are abundant and inexpensive. Since there is stable supply of the electrolyte, it is advantageous in promoting extensive use of the redox flow battery.

Nevertheless, the redox flow battery using the weakly acidic electrolyte is not put to practical use yet. Also, among the weakly acidic electrolytes, it may be very difficult for certain electrolytes to achieve the cycle life and coulomb efficiency the battery requires.

In view of the above, an objective of the invention is to provide a redox flow battery whose cycle life and coulomb efficiency are easily improved even when a particular electrolyte is used.

### Solution to the Problem

To achieve the above objective, in an embodiment of the invention, a redox flow battery includes: a charge/discharge cell, a first tank storing a positive-electrode electrolyte, a second tank storing a negative-electrode electrolyte, a first supply pipe supplying the positive-electrode electrolyte to the charge/discharge cell, and a second supply pipe supplying the negative-electrode electrolyte to the charge/discharge cell. The positive-electrode electrolyte contains an iron redox-based substance and an acid, and the acid in the positive-electrode electrolyte is a citric acid or a lactic acid. The negative-electrode electrolyte is an electrolyte containing a titanium redox-based substance and an acid, or an electrolyte containing a copper redox-based substance and an amine. The acid in the negative-electrode electrolyte is at least one of a citric acid and a lactic acid. The amine is represented by a general formula (1):

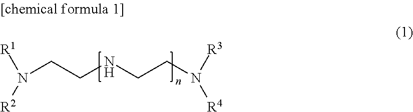

(Wherein, n represents an integer of 0-4, and R¹, R², R³, and R⁴ independently represent a hydrogen atom, a methyl group, or an ethyl group.) A dissolved oxygen amount in the negative-electrode electrolyte in the second tank is 1.5 mg/L or less.

The “redox-based substance” described in this application refers to metal ions, metal complex ions, or metal generated by the oxidation-reduction reaction of a metal. The redox flow battery may include a case surrounding the charge/discharge cell, and an oxygen concentration in the case is preferably 10 vol % or less.

In the redox flow battery, an oxygen concentration in a gas phase in the second tank is preferably 1 vol % or less.

In the redox flow battery, a pH of the positive-electrode electrolyte and the negative-electrode electrolyte is preferably in a range of 1 or more and 7 or less.

### BRIEF DESCRIPTION OF THE DRAWINGS

FIG. 1 is a schematic diagram showing the redox flow battery of an embodiment of the invention.

FIG. 2 is a schematic diagram showing a variant of the redox flow battery.

FIG. 3 is a graph showing the relationship between time and voltage according to the result of the charge/discharge test of the embodiment 1.

FIG. 4 is a graph showing the relationship between time and voltage according to the result of the charge/discharge test of the embodiment 2.

FIG. 5 is a graph showing the relationship between time and voltage according to the result of the charge/discharge test of the embodiment 3.

FIG. 6 is a graph showing the relationship between time and voltage according to the result of the charge/discharge test of the comparative example 1.

FIG. 7 is a graph showing the relationship between time and voltage according to the result of the charge/discharge test of the comparative example 2.

FIG. 8 is a graph showing the relationship between time and voltage according to the result of the charge/discharge test of the comparative example 3.

FIG. 9 is a graph showing the relationship between time and voltage according to the result of the charge/discharge test of the embodiment 6.

FIG. 10 is a graph showing the relationship between time and voltage according to the result of the charge/discharge test of the embodiment 7.

FIG. 11 is a graph showing the relationship between time and voltage according to the result of the charge/discharge test of the embodiment 8.

### DESCRIPTION OF THE EMBODIMENTS

Hereinafter, a redox flow battery according to an embodiment of the invention is described.

### <Structure of the Redox Flow Battery>

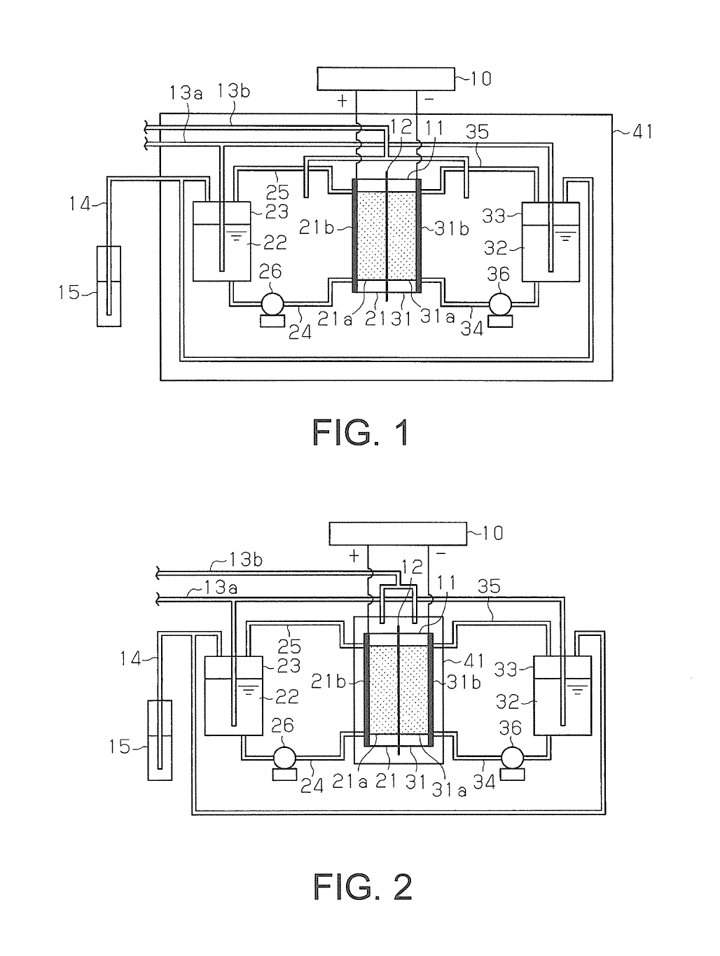

As shown in FIG. 1, the redox flow battery includes a charge/discharge cell 11, a first tank 23 for storing a positive-electrode electrolyte 22, and a second tank 33 for storing a negative-electrode electrolyte 32. The redox flow battery further includes a first supply pipe 24 for supplying the positive-electrode electrolyte 22 to the charge/discharge cell 11, and a second supply pipe 34 for supplying the negative-electrode electrolyte 32 to the charge/discharge cell 11.

The interior of the charge/discharge cell 11 is divided into a positive-electrode side cell 21 and a negative-electrode side cell 31 by a diaphragm 12.

In the positive-electrode side cell 21, a positive electrode 21a and a positive-electrode side collector plate 21b are disposed in contact with each other. In the negative-electrode side cell 31, a negative electrode 31a and a negative-electrode side collector plate 31b are disposed in contact with each other. The positive electrode 21a and the negative electrode 31a are respectively made of a carbon felt, for example. The positive-electrode side collector plate 21b and the negative-electrode side collector plate 31b are respectively made of a glassy carbon plate, for example. The collector plates 21b and 31b are electrically connected to a charge/discharge device 10. The redox flow battery is provided with a temperature control device, as required, for controlling the temperature around the charge/discharge cell 11.

The first tank 23 is connected to the positive-electrode side cell 21 via the first supply pipe 24 and a first recovery pipe 25. The first supply pipe 24 is equipped with a first pump 26. The positive-electrode electrolyte 22 in the first tank 23 is supplied to the positive-electrode side cell 21 through the first supply pipe 24 by operation of the first pump 26. In the meantime, the positive-electrode electrolyte 22 in the positive-electrode side cell 21 is recovered to the first tank 23 through the first recovery pipe 25. In this way, the positive-electrode electrolyte 22 circulates between the first tank 23 and the positive-electrode side cell 21.

The second tank 33 is connected to the negative-electrode side cell 31 via the second supply pipe 34 and a second recovery pipe 35. The second supply pipe 34 is equipped with a second pump 36. The negative-electrode electrolyte 32 in the second tank 33 is supplied to the negative-electrode side cell 31 through the second supply pipe 34 by operation of the second pump 36. In the meantime, the negative-electrode electrolyte 32 in the negative-electrode side cell 31 is recovered to the second tank 33 through the second recovery pipe 35. In this way, the negative-electrode electrolyte 32 circulates between the negative-electrode electrolyte tank 33 and the negative-electrode side cell 31.

A first gas pipe 13a is connected to the first tank 23 and the second tank 33. The first gas pipe 13a supplies an inert gas, which is supplied from an inert gas generator, into the positive-electrode electrolyte 22 in the first tank 23 and the negative-electrode electrolyte 32 in the second tank 33. Thereby, contact between the positive-electrode electrolyte 22 and the negative-electrode electrolyte 32 and oxygen in the atmosphere is suppressed. The oxygen concentrations in the gas phase in the first tank 23 and the second tank 33 are kept substantially constant by adjusting the supply amount of the inert gas.

Nitrogen gas, for example, is used as the inert gas. In addition to nitrogen gas, the inert gas that can be used may be carbon dioxide gas, argon gas, or helium gas, for example. The inert gas supplied to the first tank 23 and the second tank 33 is exhausted through an exhaust pipe 14. A water sealing part 15 for water-sealing a front end opening of the exhaust pipe 14 is disposed at the front end of the exhaust pipe 14 on the discharge side. The water sealing part 15 prevents air from flowing back into the exhaust pipe 14 and keeps the pressures in the first tank 23 and the second tank 33 at a constant level.

The redox flow battery of this embodiment includes a case 41. The case 41 surrounds the charge/discharge cell 11, the first tank 23, and the second tank 33. A second gas pipe 13b is connected to the case 41. The second gas pipe 13b supplies the inert gas, which is supplied from the inert gas generator, around the charge/discharge cell 11. Thereby, contact between the charge/discharge cell 11 and oxygen in the atmosphere is suppressed. The oxygen concentration in the case 41 is kept substantially constant by adjusting the supply amount of the inert gas.

During charging, an oxidation reaction is generated in the positive-electrode electrolyte 22 that is in contact with the positive electrode 21a while a reduction reaction is generated in the negative-electrode electrolyte 32 that is in contact with the negative electrode 31a. That is, the positive electrode 21a releases electrons while the negative electrode 31a receives electrons. In the meantime, the positive-electrode side collector plate 21b supplies the electrons released from the positive electrode 21a to the charge/discharge device 10. The negative-electrode side collector plate 31b supplies the electrons received from the charge/discharge device 10 to the negative electrode 31a.

During discharging, the reduction reaction is generated in the positive-electrode electrolyte 22 that is in contact with the positive electrode 21a while the oxidation reaction is generated in the negative-electrode electrolyte 32 that is in contact with the negative electrode 31a. That is, the positive electrode 21a receives electrons while the negative electrode 31a releases electrons. In the meantime, the positive-electrode side collector plate 21b supplies the electrons received from the charge/discharge device 10 to the positive electrode 21a.

Next, the diaphragm 12 is described.

A cation exchange membrane or an anion exchange membrane is used as the diaphragm 12. The diaphragm 12 may be porous or nonporous. The base material of the diaphragm 12 may be a polyethylene substrate, a polypropylene substrate, or an ethylene-vinyl alcohol copolymer, for example. The diaphragm 12 (ion exchange membrane) is, for example, a graft polymer obtained by graft-polymerizing a monomer having an ion exchange substituent with the substrate. The ion exchange substituent may be a cation exchange substituent (such as a sulfo group, a carboxyl group, and so on) or an anion exchange substituent (such as a primary, secondary, or tertiary amino group, a quaternary ammonium group, a pyridyl group, an imidazole group, a quaternary pyridinium group, a quaternary imidazolium group, and so on), for example. Counter ions of the cation exchange substituent may be potassium ions, sodium ions, and so on, for example. Counter ions of the anion exchange substituent may be halide ions, inorganic oxoacid anions, organic acid anions, organic sulfonic acid anions, hydroxide ions, hydrogen carbonate ions, carbonate ions, and so on, for example.

The thickness of the base material of the diaphragm 12 is preferably 15 μm or more and 50 μm or less. It is preferable to use a stretched film as the base material of the diaphragm 12. For example, a uniaxially stretched or biaxially stretched ethylene-vinyl alcohol copolymer film is used.

It is preferable to use a nonporous substrate made of an ethylene-vinyl alcohol copolymer, for example, as the base material of the diaphragm 12. Preferably, the nonporous substrate made of the ethylene-vinyl alcohol copolymer is an ethylene-vinyl alcohol copolymer film, which has a specific gravity of 1.13 or more and 1.23 or less. The specific gravity is measured according to JIS Z8807:2012. Specifically, the specific gravity can be measured using a pycnometer. From the perspective of easily securing the strength of the diaphragm 12, the content of ethylene in the ethylene-vinyl alcohol copolymer is preferably 20 mol % or more, for example. From the perspective of hydrophilicity, the content of ethylene in the ethylene-vinyl alcohol copolymer is preferably 50 mol % or less.

Preferably, the graft ratio of the nonporous substrate made of the ethylene-vinyl alcohol copolymer is 28% or more and 74% or less.

The diaphragm 12 (ion exchange membrane) is prepared by a polymerization process. In the polymerization process, a monomer, such as styrene sulfonate, is used to introduce a graft chain to a radical active site generated on the substrate. The radical active site can be generated by a radical polymerization initiator, irradiation of ionizing radiation, ultraviolet irradiation, ultrasonic irradiation, plasma irradiation, and so on, for example. Among the methods for generating the radical active site, the polymerization process using irradiation of ionizing radiation has the advantages that the production process is simple and safe and causes less impact to the environment.

The ionizing radiation may be α ray, β ray, γ ray, an electron beam, X ray, and so on, for example. Among the ionizing radiations, the γ ray emitted from a cobalt 60, the electron beam emitted from an electron beam accelerator, and X ray, for example, are preferable considering that they can be easily applied for industrial use.

From the perspective of suppressing reaction between the radical active site and oxygen, it is preferable to carry out irradiation of the ionizing radiation in an inert gas atmosphere, such as nitrogen gas, neon gas, argon gas, and so on. The absorbed dose of the ionizing radiation is set to a range of 1-300 kGy, for example. The graft ratio can be changed by adjusting the absorbed dose of the ionizing radiation.

In the polymerization process, a solution containing a monomer is disposed in contact with the substrate on which the radical active site is generated. During the contact, the substrate immersed in the solution containing the monomer may be shaken or heated to accelerate the radical polymerization reaction.

A solvent of the solution containing the monomer may be a hydrophilic solvent (e.g. water, methanol, alcohol such as ethanol, and hydrophilic ketone such as acetone), or a solvent mixture obtained by mixing multiple kinds of hydrophilic solvents, for example. From the perspective of reducing costs of the production process, reducing the environmental impact, and improving safety of the process, it is preferable to use water as the main component of the solvent that is used, and it is even more preferable to use water as the solvent. The water can be ion-exchanged water, pure water, ultrapure water, and so on, for example.

The graft ratio can be changed by adjusting the monomer concentration in the solution containing the monomer. The monomer concentration in the solution containing the monomer is in a range of 3 mass % or more and 35 mass % or less, and more preferably 5 mass % or more and 30 mass % or less, for example. If the monomer concentration is 5 mass % or more, it is easy to increase the graft ratio. If the monomer concentration is 35 mass % or less, generation of a homopolymer of the monomer is inhibited.

The time that the solution containing the monomer is in contact with the substrate on which the radical active site is generated is in a range of 30 minutes or more and 48 hours or less, for example.

Like irradiation of the ionizing radiation, preferably, the contact between the substrate on which the radical active site is generated and the solution containing the monomer is also carried out in an inert gas atmosphere, such as nitrogen gas, neon gas, argon gas, and so on.

After the polymerization process, the ion exchange membrane is washed with water in a washing process. An acid may be used in the washing process, as required.

### <Electrolyte>

The positive-electrode electrolyte 22 contains an iron redox-based substance and an acid. The acid is citric acid or lactic acid.

In the positive-electrode electrolyte 22, the iron serves as an active material. For example, it is presumed that the oxidation from iron (II) to iron (III) occurs during charging and the reduction from iron (III) to iron (II) occurs during discharging. The positive-electrode electrolyte 22 contains the aforementioned acid, and thereby a practical electromotive force is obtained easily.

From the perspective of increasing the energy density, the concentration of the iron redox-based substance (iron ions) in the positive-electrode electrolyte 22 is preferably 0.2 mol/L or more, more preferably 0.3 mol/L or more, and even more preferably 0.4 mol/L or more. The concentration of the iron redox-based substance (iron ions) in the positive-electrode electrolyte 22 is preferably 1.0 mol/L or less.

It is preferable that the molar ratio of the aforementioned acid to the iron redox-based substance in the positive-electrode electrolyte 22 is in a range of 1 or more and 4 or less. If the molar ratio is 1 or more, the electrical resistance of the positive-electrode electrolyte 22 further decreases, and thus the coulomb efficiency and the utilization rate of the positive-electrode electrolyte 22 are improved easily. If the molar ratio is 4 or less, it is easy to achieve both economic efficiency and practicality.

To easily ensure the solubility of the iron redox-based substance and the acid, for example, the pH of the positive-electrode electrolyte 22 is preferably in a range of 1 or more and 7 or less, and more preferably in a range of 2 or more and 5 or less. The pH is a value measured at 20° C., for example.

The positive-electrode electrolyte 22 can also contain an inorganic acid salt or a chelating agent, for example, as required.

The negative-electrode electrolyte 32 is an electrolyte that contains a titanium redox-based substance and an acid, or an electrolyte that contains a copper redox-based substance and an amine. The acid is citric acid or lactic acid. The amine is represented by the following general formula (1).

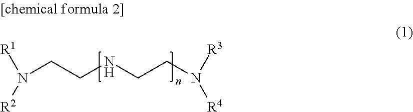

Wherein, in the general formula (1), n represents an integer of 0-4, and R¹, R², R³, and R⁴ independently represent a hydrogen atom, a methyl group, or an ethyl group.

The amine represented by the general formula (1) is a kind of chelating agent and can generate a complex with the copper redox-based substance. Accordingly, when the copper redox-based substance is used in the negative-electrode electrolyte 32, it serves to stabilize the redox reaction, for example.

The amine represented by the general formula (1) may be ethylenediamine (EDA, n=0), diethylenetriamine (DETA, n=1), triethylenetetramine (TETA, n=2), tetraethylenepentamine (TEPA, n=3), pentaethylenehexamine (PEHA, n=4), tetramethylethylenediamine (TMEDA, n=0), N-methyl ethylene diamine (n=0), N,N′-dimethyl-ethylenediamine (TMEDA, n=0), N,N-dimethylethylenediamine (n=0), N-methyl ethylene diamine (n=0), N,N′-diethyl-ethylenediamine (n=0), and N,N-diethyl ethylenediamine (n=0), for example.

If the negative-electrode electrolyte 32 contains the copper redox-based substance, the negative-electrode electrolyte 32 may contain only one kind or multiple kinds of the amine represented by the general formula (1).

If the negative-electrode electrolyte 32 contains the copper redox-based substance, it is preferable that the negative-electrode electrolyte 32 contains at least one amine selected from diethylenetriamine, triethylenetetramine, and N,N′-dimethylethylenediamine.

In the negative-electrode electrolyte 32, the titanium or copper serves as an active material. For example, it is presumed that the reduction from titanium (IV) or copper (II) to titanium (III) or copper (I) occurs during charging and the oxidation from titanium (III) or copper (I) to titanium (IV) or copper (II) occurs during discharging. The negative-electrode electrolyte 32 contains the aforementioned acid or amine, and thereby a practical electromotive force is obtained easily.

From the perspective of increasing the energy density, the concentration of the titanium or copper redox-based substance (titanium ions or copper ions) in the negative-electrode electrolyte 32 is preferably 0.2 mol/L or more, more preferably 0.3 mol/L or more, and even more preferably 0.4 mol/L or more. The concentration of the titanium or copper redox-based substance (titanium ions or copper ions) in the negative-electrode electrolyte 32 is preferably 1.0 mol/L or less.

The molar ratio of the aforementioned acid to the titanium redox-based substance (titanium ions) in the negative-electrode electrolyte 32 is preferably in a range of 1 or more and 4 or less, and more preferably in a range of 1 or more and 2 or less. If the molar ratio is 1 or more, the electrical resistance of the negative-electrode electrolyte 32 further decreases, and thus the coulomb efficiency and the utilization rate of the negative-electrode electrolyte 32 are improved easily. If the molar ratio is 4 or less, it is easy to achieve both economic efficiency and practicality.

It is preferable that the molar ratio of the amine represented by the general formula (1) to the copper redox-based substance (copper ions) in the negative-electrode electrolyte 32 is in a range of 1 or more and 5 or less. If the molar ratio is 1 or more, it is easier to suppress precipitation of the copper redox-based substance. If the molar ratio is 5 or less, it is easy to achieve both economic efficiency and practicality.

To easily ensure the solubility of the titanium or copper redox-based substance and the acid or amine, for example, the pH of the negative-electrode electrolyte 32 is preferably in a range of 1 or more and 7 or less. If the negative-electrode electrolyte 32 contains the titanium redox-based substance, the pH of the negative-electrode electrolyte 32 is more preferably in a range of 2 or more and 5 or less. If the negative-electrode electrolyte 32 contains the copper redox-based substance, the pH of the negative-electrode electrolyte 32 is more preferably in a range of 3 or more and 6 or less.

The negative-electrode electrolyte 32 can also contain an inorganic acid salt or a chelating agent other than the amine represented by the general formula (1), for example, as required.

If the negative-electrode electrolyte 32 contains the titanium redox-based substance, it is preferable that the pH of the negative-electrode electrolyte 32 is adjusted by using at least one amine compound, which is selected from ammonia and the amine represented by the general formula (1), and sodium hydroxide. In that case, the molar ratio of the amine group (ammonia, in the case that the amine compound is ammonia) that has the aforementioned amine compound to the titanium ions (titanium) is preferably 1 or more and 4 or less. In addition, the molar ratio of the sodium hydroxide to the titanium ions (titanium) is preferably 1 or more and 4 or less.

The positive-electrode electrolyte 22 and the negative-electrode electrolyte 32 can be prepared by a conventional method. It is preferable that the water to be used in the positive-electrode electrolyte 22 and the negative-electrode electrolyte 32 has purity equal to or higher than distilled water.

<Dissolved Oxygen Amount and Oxygen Concentration>

In the redox flow battery having the configuration described above, the dissolved oxygen amount in the negative-electrode electrolyte 32 in the second tank 33 is set to 1.5 mg/L or less. The dissolved oxygen amount is more preferably 1.0 mg/L or less. Moreover, the oxygen concentration in the case 41 is preferably 10 vol % or less. Further, the oxygen concentration in the gas phase in the second tank 33 is preferably 1 vol % or less.

Also, the dissolved oxygen amount in the positive-electrode electrolyte 22 in the first tank 23 may be set to 1.5 mg/L or less, or 1.0 mg/L or less. In addition, the oxygen concentration in the gas phase in the first tank 23 may be set to 1 vol % or less.

<Function of the Redox Flow Battery>

By using the aforementioned positive-electrode electrolyte 22 and negative-electrode electrolyte 32, electrolysis of the water contained in the electrolytes can be avoided as much as possible. However, the titanium redox-based substance and the copper redox-based substance are susceptible to oxygen. Therefore, the redox battery is likely to self-discharge due to oxidation of the negative-electrode electrolyte 32. Regarding this, the dissolved oxygen amount in the negative-electrode electrolyte 32 is 1.5 mg/L or less according to this embodiment. Thus, the reaction between the titanium redox-based substance or the copper redox-based substance and oxygen is suppressed.

Performance of the redox flow battery can be evaluated based on the charge/discharge cycle characteristic (reversibility), coulomb efficiency, voltage efficiency, energy efficiency, utilization rate of the electrolyte, electromotive force, and potential of the electrolyte, for example. In the following description, charge and discharge of the redox flow battery for once is one cycle.

The charge/discharge cycle characteristic (reversibility) is calculated by substituting a coulomb amount (A) of discharge of the first cycle and a coulomb amount (B) of discharge of the tenth cycle into the following equation (1).

Charge/discharge cycle characteristic [%]=B/A×100 (1)

The charge/discharge cycle characteristic is preferably 80% or more.

The coulomb efficiency is calculated by substituting a coulomb amount (C) of charge and a coulomb amount (D) of discharge of a predetermined cycle into the following equation (2).

Coulomb efficiency [%]=D/C×100 (2)

The coulomb efficiency is preferably 90% or more, based on the value obtained from the coulomb amount of the tenth cycle, for example.

The voltage efficiency is calculated by substituting an average terminal voltage (E) of charge and an average terminal voltage (F) of discharge of a predetermined cycle into the following equation (3).

Voltage efficiency [%]=F/E×100 (3)

The voltage efficiency is preferably 70% or more, based on the value obtained from the terminal voltage of the tenth cycle, for example.

The energy efficiency is calculated by substituting a power amount (G) of charge and a power amount (H) of discharge of a predetermined cycle into the following equation (4).

Energy efficiency [%]=H/G×100 (4)

The energy efficiency is preferably 70% or more, based on the value obtained from the power amount of the tenth cycle.

The utilization rate of the electrolyte is calculated by multiplying the number of moles of active material in the electrolyte supplied to the side of the positive electrode 21a or the side of the negative electrode 31a by a Faraday constant (96500 coulombs/mol) to determine a coulomb amount (I) as well as determining a coulomb amount (J) of discharge of the tenth cycle, and then substituting the coulomb amount (I) and the coulomb amount (J) into the following equation (5). If the number of moles of the active material in the electrolyte supplied to the side of the positive electrode 21a and the number of moles of the active material in the electrolyte supplied to the side of the negative electrode 31a are different, the smaller number of moles is adopted.

Utilization rate of electrolyte [%]=J/I×100 (5)

The utilization rate of the electrolyte is preferably 35% or more, based on the value obtained from the discharge coulomb amount of the tenth cycle.

The electromotive force is set to a terminal voltage at the time of switching from charge to discharge in a predetermined cycle (when the current is 0 mA). Regarding the electromotive force, the terminal voltage of the tenth cycle is preferably 0.8V or more.

According to this embodiment as described above, the following effects are achieved.

(1) The positive-electrode electrolyte 22 of the redox flow battery of this embodiment contains the iron redox-based substance and the acid. The negative-electrode electrolyte 32 is an electrolyte that contains the titanium redox-based substance and the acid, or an electrolyte that contains the copper redox-based substance and the amine. The acid respectively used in the electrolytes 22 and 32 is citric acid or lactic acid. The amine used in the negative-electrode electrolyte 32 is represented by the general formula (1). In the redox flow battery, the dissolved oxygen amount in the negative-electrode electrolyte 32 in the second tank 33 is 1.5 mg/L or less. Therefore, it is easy to improve the cycle life and coulomb efficiency even if the aforementioned particular electrolyte is used.
(2) It is preferable that the redox flow battery includes the case 41 surrounding the charge/discharge cell 11, and that the oxygen concentration in the case 41 is set to 10 vol % or less. In this case, since the amount of oxygen that enters the charge/discharge cell 11 from the outside can be reduced, it is easy to set the dissolved oxygen amount in the negative-electrode electrolyte 32 in the second tank 33 to 1.5 mg/L or less.
(3) By setting the oxygen concentration in the gas phase in the second tank 33 to 1 vol % or less, the oxygen absorbed by the negative-electrode electrolyte 32 in the second tank 33 is reduced. Therefore, it is easy to set the dissolved oxygen amount in the negative-electrode electrolyte 32 to 1.5 mg/L or less.
(4) The pH of the positive-electrode electrolyte 22 and the negative-electrode electrolyte 32 is respectively in the range of 1 or more and 7 or less. Thereby, it is easy to ensure both the corrosion resistance and the solubility of the aforementioned metal redox-based substance.

(Variant)

The above embodiment may be varied as follows.

The case 41 may be omitted. In such a case, it is still possible to set the dissolved oxygen amount in the negative-electrode electrolyte 32 to 1.5 mg/L or less, for example, by enhancing the airtightness of the circulatory system of the charge/discharge cell 11 or the negative-electrode electrolyte 32. However, the outside air is likely to enter the charge/discharge cell 11 from the support portion of the diaphragm 12, for example. Therefore, as shown in FIG. 2, it is preferable that the redox flow battery includes the case 41 that surrounds the charge/discharge cell 11, and preferably, the oxygen concentration in the case 41 is set to 10 vol % or less. In this way, since the oxygen that enters the charge/discharge cell 11 can be reduced, it is easy to set the dissolved oxygen amount in the negative-electrode electrolyte 32 in the second tank 33 to 1.5 mg/L or less.

The shape, configuration, or number of the charge/discharge cell 11 of the redox flow battery or the capacities of the first tank 23 and the second tank 33 may be changed according to the performance of the redox flow battery required. Furthermore, the amounts of the positive-electrode electrolyte 22 and the negative-electrode electrolyte 32 supplied to the charge/discharge cell 11 can also be set according to the capacity of the charge/discharge cell 11, for example.

### EMBODIMENTS

Next, the invention is further described in detail based on the embodiments and comparative examples.

### Embodiment 1

### Redox Flow Battery

The redox flow battery as shown in FIG. 1 was used. A carbon felt (Product Name: GFA5, produced by SGL) was used as the positive electrode and the negative electrode, and the electrode area was set to 10 cm². Regarding the collector plate, pure titanium having a thickness of 1.0 mm was used. An anion exchange membrane (AHA, produced by ASTOM Corporation) was used as the diaphragm.

Glass containers each having a capacity of 30 mL were used as the first tank and the second tank. Silicone tubes were used as the supply pipes, recovery pipes, gas pipes, and the exhaust pipe. A micro-tube pump (MP-1000, produced by Tokyo Rikakikai Co., LTD.) respectively served as the pump. A charge/discharge battery test system (PFX200, produced by Kikusui Electronics Corp.) was used as the charge/discharge device.

<Preparation of Iron (II)-Citric Acid Complex Aqueous Solution>

0.04 mol (8.4 g) of citric acid was dissolved in 50 mL of distilled water. 0.01 mol (0.4 g) of NaOH was added to the aqueous solution to adjust the pH to 2. 0.02 mol (5.56 g) of FeSO₄.7H₂O was dissolved in the aqueous solution. Then, distilled water was added to the aqueous solution to make the total amount 100 mL. Thereby, an aqueous solution with the concentration of the iron (II)-citric acid complex being 0.2 mol/L was obtained.

<Preparation of Titanium (IV)-Citric Acid Complex Aqueous Solution>

0.04 mol (8.4 g) of citric acid was dissolved in 50 mL of distilled water. 0.12 mol (4.8 g) of NaOH was added to the aqueous solution to adjust the pH to 6. 16 g of a solution with 30 mass % of titanium sulfate (equivalent to 0.02 mol of titanium sulfate) was added to the aqueous solution and stirred until the aqueous solution became clear. Then, 0.2 mol (11.69 g) of NaCl was dissolved in the aqueous solution and distilled water was added to make the total amount 100 mL. Thereby, an aqueous solution with the concentration of the titanium (IV)-citric acid complex being 0.2 mol/L was obtained.

<Adjustment of Dissolved Oxygen Amount and Oxygen Concentration>

The iron (II)-citric acid complex aqueous solution was used as the positive-electrode electrolyte while the titanium (IV)-citric acid complex aqueous solution was used as the negative-electrode electrolyte. Nitrogen gas was supplied from the first gas pipe, so as to perfoini bubbling of each electrolyte and adjust the dissolved oxygen amount in each electrolyte and the oxygen concentration in the gas phase in each tank. The supply of the nitrogen gas from the first gas pipe was continued in the subsequent charge/discharge test.

Then, nitrogen was supplied into the case from the second gas pipe, so as to adjust the oxygen concentration in the ambient atmosphere of the charge/discharge cell. The supply of the nitrogen gas from the second gas pipe was continued in the subsequent charge/discharge test.

The dissolved oxygen amount was measured by a dissolved oxygen meter (produced by Iijima Electronics Corporation, “B-506”).

The oxygen concentration was measured by an oxygen concentration meter (produced by New Cosmos Electric Co., Ltd., “XPO-318”).

<Charge/Discharge Test>

The charge/discharge test started with charging. First, the redox flow battery was charged 60 minutes at a constant current of 50 mA (a total of 180 coulombs). Then, the redox flow battery was discharged at a constant current of 50 mA with a discharge end voltage set to 0V.

The charge and discharge described above were set as one cycle, and the cycle was repeated 100 times.

It is presumed that the redox reaction during the charging and discharging is as follows. Positive electrode: iron (II)-citric acid complex [symbol] iron (III)-citric acid complex+e⁻ Negative electrode: titanium (IV)-citric acid complex+e⁻ [symbol] titanium (III)-citric acid complex
In the charge/discharge test, the charge/discharge cycle characteristic (reversibility), coulomb efficiency, energy efficiency, utilization rate of the electrolyte, and electromotive force were determined.

The charge/discharge cycle characteristic (reversibility) was determined by the coulomb amount (A) of discharge of the first cycle and the coulomb amount (B) of discharge of the tenth cycle.

The coulomb efficiency was determined by the coulomb amount of the tenth cycle.

The energy efficiency was determined by the power amount of the tenth cycle. The utilization rate of the electrolyte was determined by the coulomb amount of the tenth cycle.

The electromotive force was set to be the terminal voltage of the tenth cycle.

### Embodiment 2

In the embodiment 2, the charge/discharge test was performed in the same manner as the embodiment 1, except that the iron (II)-lactic acid complex aqueous solution described below was used as the positive-electrode electrolyte and the titanium (IV)-lactic acid complex aqueous solution described below was used as the negative-electrode electrolyte.

<Preparation of Iron (II)-Lactic Acid Complex Aqueous Solution>

90 mass % of lactic acid aqueous solution was mixed with 50 mL of distilled water such that the lactic acid was 0.08 mol (8 g). 0.01 mol (0.4 g) of NaOH was added to the aqueous solution to adjust the pH to 3. 0.02 mol (5.56 g) of FeSO₄.7H₂O was dissolved in the aqueous solution. Then, distilled water was added to the aqueous solution to make the total amount 100 mL. Thereby, an aqueous solution with the concentration of the iron (II)-lactic acid complex being 0.2 mol/L was obtained.

<Preparation of Titanium (IV)-Lactic Acid Complex Aqueous Solution>

90 mass % of lactic acid aqueous solution was mixed with 50 mL of distilled water such that the lactic acid was 0.08 mol (8 g). 0.12 mol (4.8 g) of NaOH was added to the aqueous solution to adjust the pH to 6. 16 g of a solution with 30 mass % of titanium sulfate (equivalent to 0.02 mol of titanium sulfate) was added to the aqueous solution and stirred until the aqueous solution became clear. Then, 0.2 mol (11.69 g) of NaCl was dissolved in the aqueous solution and distilled water was added to make the total amount 100 mL. Thereby, an aqueous solution with the concentration of the titanium (IV)-lactic acid complex being 0.2 mol/L was obtained.

### Embodiment 3

In the embodiment 3, the charge/discharge test was performed in the same manner as the embodiment 1, except that a copper (II)-TETA complex aqueous solution described below was used as the negative-electrode electrolyte. It is presumed that the redox reaction of the negative electrode during the charging and discharging is as follows.

Negative electrode: copper (II)-TETA complex+e⁻ [symbol] copper (I)-TETA complex

Moreover, in the charge/discharge test of the embodiment 3, the coulomb efficiency, energy efficiency, utilization rate of the electrolyte, and electromotive force were determined according to the result of the tenth cycle.

<Preparation of Copper (II)-TETA Complex Aqueous Solution>

0.02 mol (2.92 g) of triethylenetetramine (TETA) was dissolved in 50 mL of distilled water. After 0.02 mol (3.19 g) of CuSO₄ was dissolved in the aqueous solution, 0.2 mol (11.69 g) of NaCl was further dissolved. Next, 2.5 mol/L of dilute sulfuric acid was added to the aqueous solution to adjust the pH to 6. Thereafter, distilled water was added to make the total amount 100 mL. Thereby, an aqueous solution with the concentration of the copper (II)-TETA complex being 0.2 mol/L was obtained.

### Embodiments 4 and 5

In the embodiments 4 and 5, the charge/discharge test was performed in the same manner as the embodiment 1, except that the oxygen concentration in the ambient atmosphere of the charge/discharge cell was varied. The oxygen concentration in the ambient atmosphere of the charge/discharge cell was adjusted by sending air into the case using an air pump and adjusting the flow rate of nitrogen gas.

### Comparative Example 1

In the comparative example 1, the charge/discharge test was performed in the same manner as the embodiment 1, except that the ambient atmosphere of the charge/discharge cell was air.

### Comparative Example 2

In the comparative example 2, the charge/discharge test was performed in the same manner as the embodiment 2, except that the ambient atmosphere of the charge/discharge cell was air.

### Comparative Example 3

In the comparative example 3, the charge/discharge test was performed in the same manner as the embodiment 3, except that the ambient atmosphere of the charge/discharge cell was air.

### Comparative Example 4

In the comparative example 4, the charge/discharge test was performed using a vanadium-based redox flow battery, which is the most widely used among the conventional redox flow batteries.

<Redox Flow Battery>

In order to use a strongly acidic vanadium-based electrolyte, the cell frame was formed using an acid-resistant resin, and SG carbon (produced by Showa Denko K.K., thickness 0.6 mm) was used as the collector plate. The ambient atmosphere of the charge/discharge cell was air. An anion exchange membrane (AFN, produced by ASTOM Corporation) was used as the diaphragm. With the exception of the above, the configuration is the same as the embodiment 1.

<Preparation of Vanadium (IV) Solution>

0.17 mol (33.1 g) of vanadium (IV) OSO₄.3 hydrate was dissolved in 50 mL of 5.2 mol/L sulfuric acid solution. Then, distilled water was added to the aqueous solution to make the total amount 100 mL. Thereby, a 1.7 mol/L vanadium (IV) solution was obtained.

<Preparation of Vanadium (III) Solution>

16 mL of the aforementioned 1.7 mol/L vanadium (IV) solution was respectively put in the first tank and the second tank. The redox flow battery was charged 110 minutes at 400 mA (a total of 2625 coulombs). In the meantime, the negative-electrode electrolyte was reduced from vanadium (IV) solution to vanadium (III) solution. Thereby, a vanadium (III) solution was prepared. Next, the following adjustment of the dissolved oxygen amount and charge/discharge test were performed by replacing the positive-electrode electrolyte with the 1.7 mol/L vanadium (IV) solution.

<Adjustment of Dissolved Oxygen Amount>

Nitrogen gas was supplied from the first gas pipe, so as to perform bubbling of each electrolyte and adjust the dissolved oxygen amount in each electrolyte and the oxygen concentration in the gas phase in each tank.

<Charge/Discharge Test>

The charge/discharge test was performed by using the vanadium (IV) solution as the positive-electrode electrolyte and the vanadium (III) as the negative-electrode electrolyte. In the charge/discharge test, the charging was started at a constant current of 400 mA and stopped at a charge end voltage of 1.6V. Then, the discharging was started at a constant current of 400 mA and stopped at a discharge end voltage of 0.3V.

(Result of the Charge/Discharge Test)

Table 1 shows the conditions of the dissolved oxygen amount and oxygen concentration in the charge/discharge tests of the embodiments 1-5 and the comparative examples 1-4, and the results of the charge/discharge tests.

TABLE 1

| | | Embodiment | | | | | Comparative Example | | | |
|---|---|---|---|---|---|---|---|---|---|---|
| | | 1 | 2 | 3 | 4 | 5 | 1 | 2 | 3 | 4 |
| dissolved oxygen amount [mg/L] | | 0.8 | 0.8 | 0.8 | 1.1 | 1.4 | 2.2 | 2.2 | 2.2 | 1.7 |
| oxygen | in gas phase in | 1 | 1 | 1 | 1 | 1 | 1 | 1 | 1 | 1 |
| concentration | each tank | | | | | | | | | |
| [vol %] | around | 1 | 1 | 1 | 5.4 | 10 | 21 | 21 | 21 | 21 |
| | charge/discharge | | | | | | | | | |
| | cell | | | | | | | | | |

| | | | | | | | | | |
|---|---|---|---|---|---|---|---|---|---|
| charge/discharge cycle | 116 | 106 | 117 | — | — | — | — | — | 102 |
| characteristic [%] | | | | | | | | | |
| coulomb efficiency [%] | 99 | 99 | 92 | 88 | 81 | 61 | 52 | 49 | 96 |
| energy efficiency [%] | 75 | 60 | 33 | 56 | 46 | 25 | 30 | 25 | 78 |
| utilization rate of electrolyte [%] | 47 | 46 | 42 | — | — | 29 | 25 | 23 | 25 |
| electromotive force [V] | 0.9 | 1.0 | 0.7 | — | — | — | — | — | 1.3 |

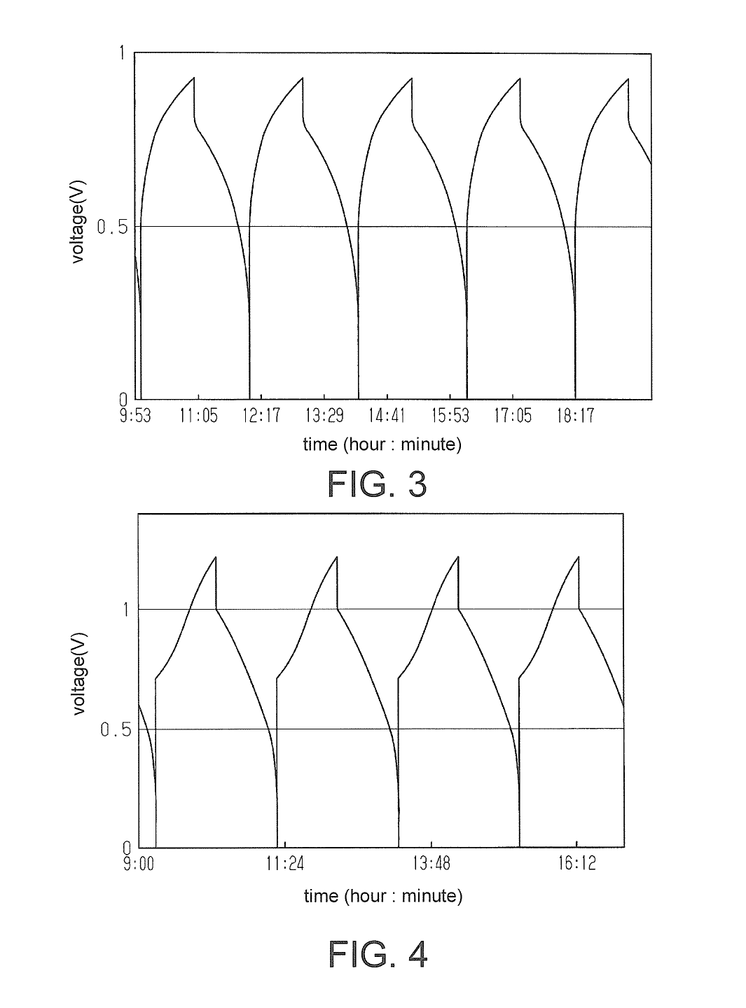

FIG. 3 shows the change of battery voltage during the charging and discharging from the tenth cycle to the thirteen cycle according to the charge/discharge test of the embodiment 1.

FIG. 4 shows the change of battery voltage during the charging and discharging from the tenth cycle to the thirteen cycle according to the result of the charge/discharge test of the embodiment 2.

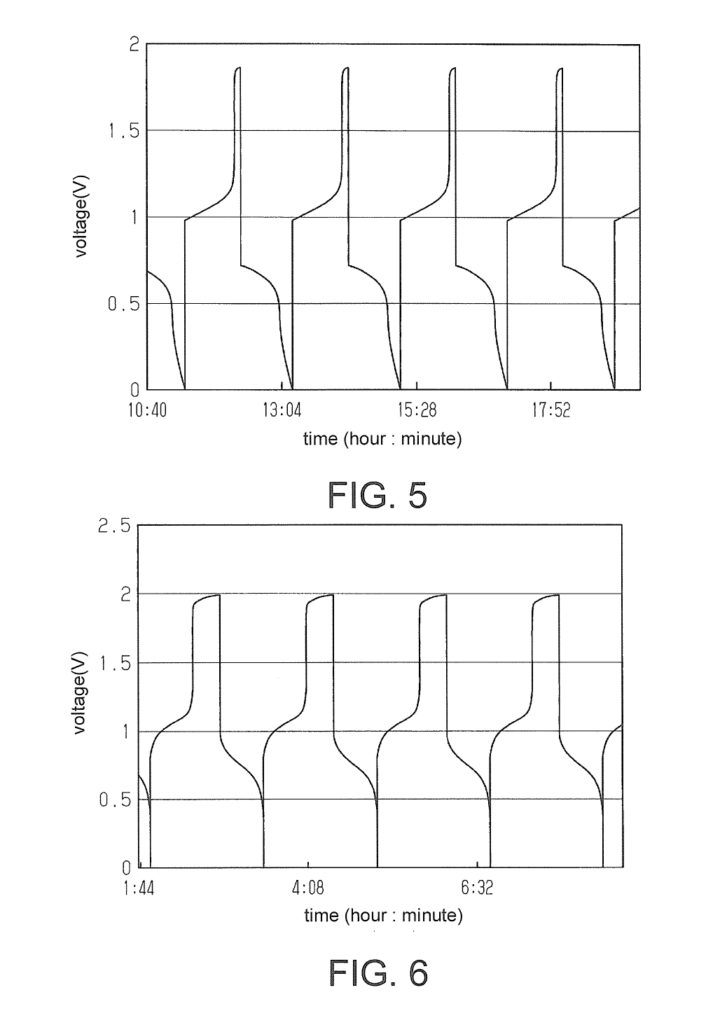

FIG. 5 shows the change of battery voltage during the charging and discharging from the tenth cycle to the thirteen cycle according to the result of the charge/discharge test of the embodiment 3.

It is known from the results of the charge/discharge tests shown in FIG. 3 to FIG. 5 that favorable cycle life is achieved in the embodiments 1-3.

As shown in Table 1, the coulomb efficiency of the embodiment 1 is higher than those of the embodiments 4 and 5. However, in the case of using the strongly acidic vanadium-based electrolyte as shown in the comparative example 4, favorable coulomb efficiency is achieved even if the dissolved oxygen concentration is higher. It is known from the result that the weakly acidic electrolyte used in the embodiments 1-5 is particularly susceptible to oxygen. Like this, the aforementioned weakly acidic electrolyte has technical issues that cannot be predicted based on the conventional strongly acidic electrolyte. That is, in terms of enhancing the coulomb efficiency, in the case of using the weakly acidic electrolyte, it is preferable to reduce the dissolved oxygen amount compared to the case of using the conventional strongly acidic electrolyte.

FIG. 6 shows the change of battery voltage during the charging and discharging from the tenth cycle to the thirteen cycle according to the result of the charge/discharge test of the comparative example 1. It is known from the result that, because the negative electrode self-discharges and causes the positive electrode to be overcharged, the comparative example 1 has a poor cycle life.

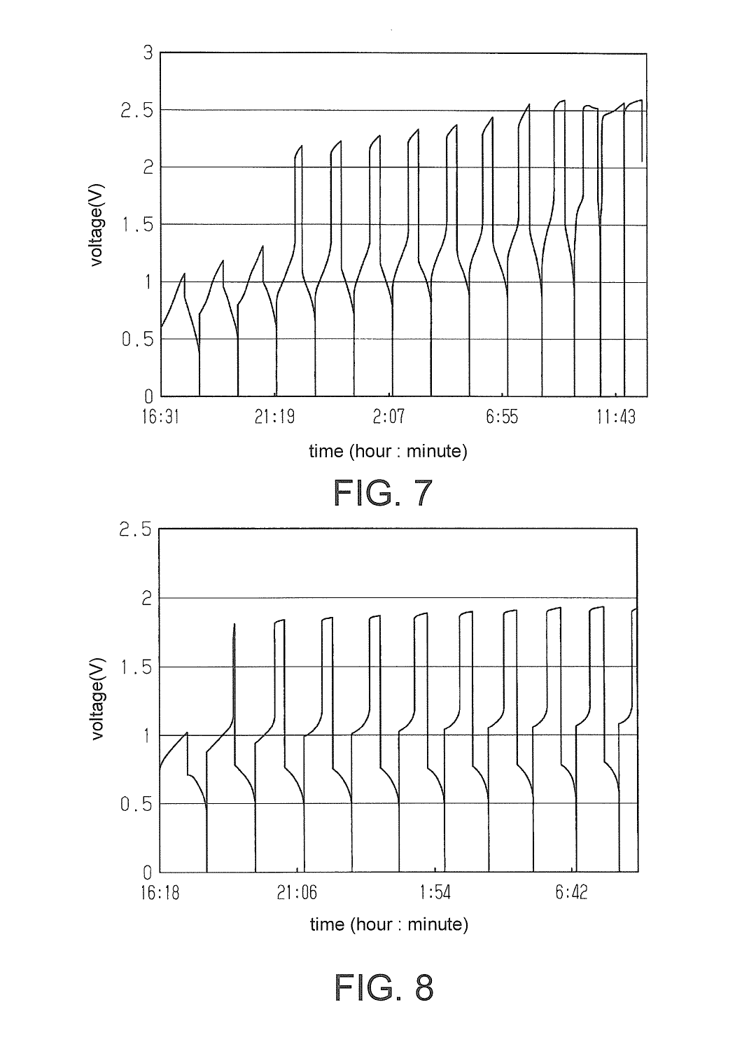

FIG. 7 shows the change of battery voltage during the charging and discharging from the first cycle to the thirteen cycle according to the result of the charge/discharge test of the comparative example 2. It is known from the result that, in the comparative example 2, the redox flow battery cannot be charged/discharged 12 cycles or more.

FIG. 8 shows the change of battery voltage during the charging and discharging from the first cycle to the tenth cycle according to the result of the charge/discharge test of the comparative example 3. It is known from the result that, because the negative electrode self-discharges and causes the positive electrode to be overcharged, the comparative example 3 has a poor cycle life.

### Embodiment 6

In the embodiment 6, as shown in Table 2, an amine compound (ammonia) was used for the pH adjustment of the titanium (IV)-citric acid complex aqueous solution. Here, the description focuses on the differences between this embodiment and the embodiment 1.

<Preparation of Iron (II)-Citric Acid Complex Aqueous Solution>

0.14 mol (29.4 g) of citric acid was dissolved in 50 mL of distilled water. 0.07 mol (2.8 g) of NaOH was added to the aqueous solution to adjust the pH to 2. 0.07 mol (13.9 g) of FeCl.4H₂O was dissolved in the aqueous solution. Then, distilled water was added to the aqueous solution to make the total amount 100 mL. Thereby, an aqueous solution with the concentration of the iron (II)-citric acid complex being 0.7 mol/L was obtained.

<Preparation of Titanium (IV)-Citric Acid Complex Aqueous Solution>

0.14 mol (29.4 g) of citric acid was dissolved in 30 mL of distilled water. After 12.8 g of 28 mass % ammonia water (equivalent to 0.21 mol of ammonia) was added to the aqueous solution, 0.21 mol (8.4 g) of NaOH was added to adjust the pH to 5. 21 g of a TiCl₄ aqueous solution with the concentration of titanium being 16 mass % (equivalent to 0.07 mol of titanium) was added to the aqueous solution. Then, distilled water was added to the aqueous solution to make the total amount 100 mL, and the aqueous solution was heated to 60° C. and stirred until the aqueous solution became clear. Thereby, an aqueous solution with the concentration of the titanium (IV)-citric acid complex being 0.7 mol/L was obtained.

<Adjustment of Dissolved Oxygen Amount and Oxygen Concentration>

In the embodiment 6, adjustment of the dissolved oxygen amount and the oxygen concentration was performed in the same manner as the embodiment 1.

### <Charge/Discharge Test>

The charge/discharge test started with charging. First, the redox flow battery was charged 5 hours and 36 minutes at a constant current of 50 mA (a total of 1008 coulombs). Then, the redox flow battery was discharged at a constant current of 50 mA with a discharge end voltage set to 0V.

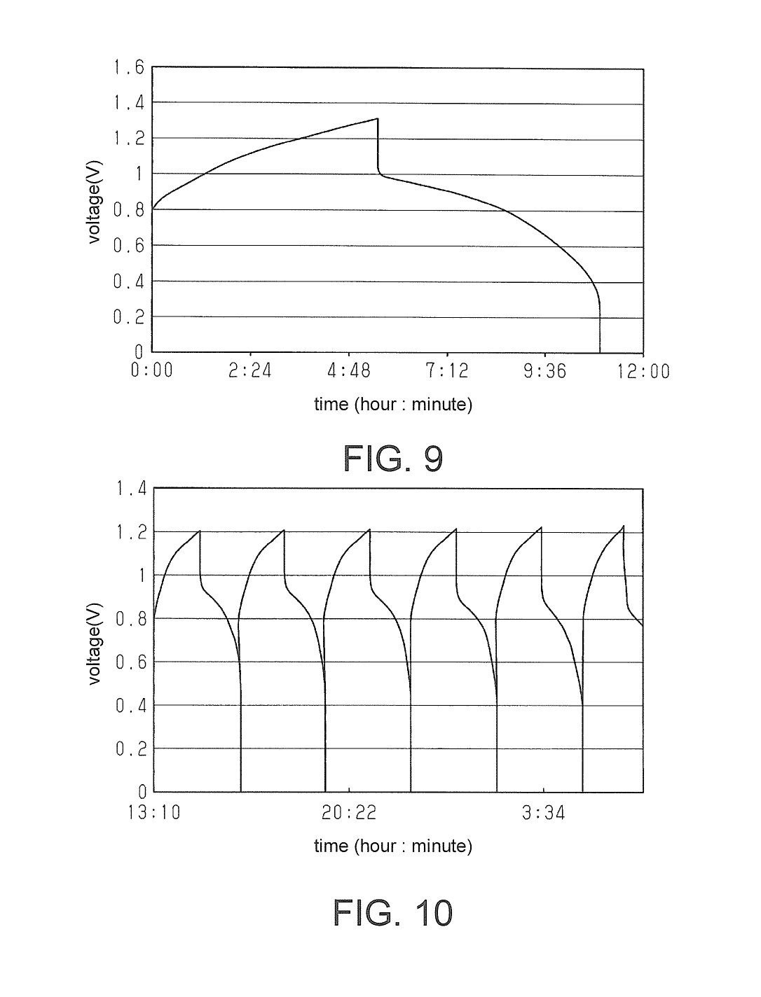

In the embodiment 6, simply the coulomb efficiency, energy efficiency, utilization rate of the electrolyte, and electromotive force with respect to one cycle of charging and discharging were determined. Table 2 shows components of the titanium (IV)-citric acid complex aqueous solution in the embodiment 6 and the result of the charge/discharge test. In addition, FIG. 9 shows the change of battery voltage during the charging and discharging of the first cycle according to the result of the charge/discharge test of the embodiment 6.

### Embodiment 7

In the embodiment 7, as shown in Table 2, an amine compound (ammonia) was used for the pH adjustment of the titanium (IV)-citric acid complex aqueous solution. Here, the description focuses on the differences between this embodiment and the embodiment 1.

<Preparation of Iron (II)-Citric Acid Complex Aqueous Solution>

0.04 mol (8.4 g) of citric acid was dissolved in 50 mL of distilled water. 0.01 mol (0.4 g) of NaOH was added to the aqueous solution to adjust the pH to 2. 0.02 mol (4.0 g) of FeCl.4H₂O was dissolved in the aqueous solution. Then, distilled water was added to the aqueous solution to make the total amount 100 mL. Thereby, an aqueous solution with the concentration of the iron (II)-citric acid complex being 0.2 mol/L was obtained.

<Preparation of Titanium (IV)-Citric Acid Complex Aqueous Solution>

0.04 mol (8.4 g) of citric acid was dissolved in 30 mL of distilled water. After 3.6 g of 28 mass % ammonia water (equivalent to 0.06 mol of ammonia) was added to the aqueous solution, 0.06 mol (2.4 g) of NaOH was added to adjust the pH to 5. 6 g of a TiCl₄ aqueous solution with the concentration of titanium being 16 mass % (equivalent to 0.02 mol of titanium) was added to the aqueous solution. Then, distilled water was added to the aqueous solution to make the total amount 100 mL, and the aqueous solution was heated to 60° C. and stirred until the aqueous solution became clear. Thereby, an aqueous solution with the concentration of the titanium (IV)-citric acid complex being 0.2 mol/L was obtained.

<Adjustment of Dissolved Oxygen Amount and Oxygen Concentration>

In the embodiment 7, adjustment of the dissolved oxygen amount and the oxygen concentration was performed in the same manner as the embodiment 1.

<Charge/Discharge Test>

The charge/discharge test started with charging. First, the redox flow battery was charged 1 hour and 48 minutes at a constant current of 50 mA (a total of 324 coulombs). Then, the redox flow battery was discharged at a constant current of 50 mA with a discharge end voltage set to 0V.

The charging and discharging were performed 5 cycles, and the charge/discharge cycle characteristic (reversibility), coulomb efficiency, energy efficiency, utilization rate of the electrolyte, and electromotive force with respect to the fifth cycle were determined. Table 2 shows components of the titanium (IV)-citric acid complex aqueous solution in the embodiment 7 and the result of the charge/discharge test. Moreover, FIG. 10 shows the change of battery voltage during the charging and discharging from the first cycle to the fifth cycle according to the result of the charge/discharge test of the embodiment 7.

### Embodiment 8

In the embodiment 8, as shown in Table 2, an amine compound (diethylenetriamine) was used for the pH adjustment of the titanium (IV)-citric acid complex aqueous solution. In the embodiment 8, the charge/discharge test was performed in the same manner as the embodiment 7 except that the 0.6 mol/L of ammonia contained in the titanium (IV)-citric acid complex aqueous solution of the embodiment 7 was changed to 0.2 mol/L of diethylene triamine.

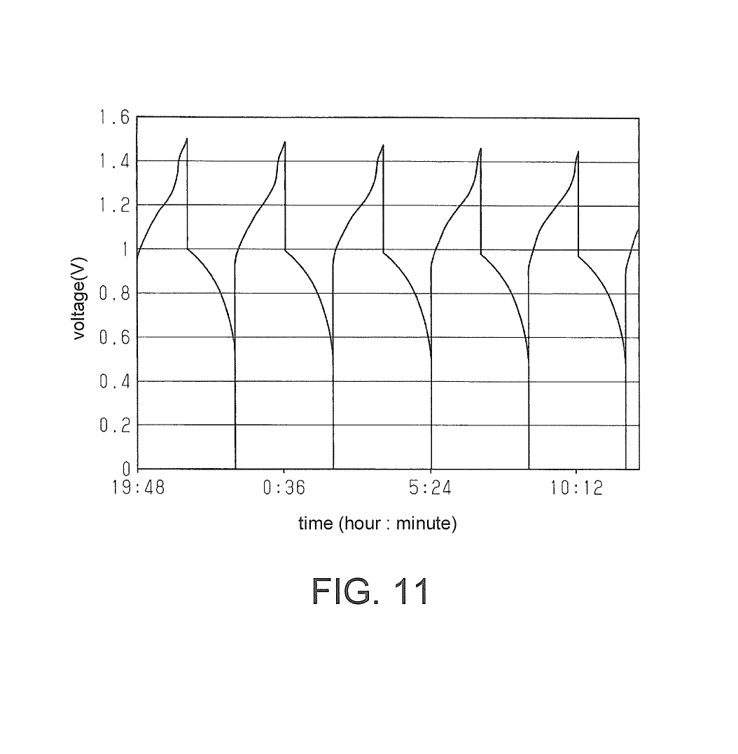

Table 2 shows components of the titanium (IV)-citric acid complex aqueous solution in the embodiment 8 and the result of the charge/discharge test. Moreover, FIG. 11 shows the change of battery voltage during the charging and discharging from the first cycle to the fifth cycle according to the result of the charge/discharge test of the embodiment 8.

TABLE 2

| | | Embodiment | | |
|---|---|---|---|---|
| <titanium (IV)-citric acid complex aqueous solution> | | 6 | 7 | 8 |
| TiCl₄ [mol/L] | | 0.7 | 0.2 | 0.2 |
| citric acid [mol/L] | | 1.4 | 0.4 | 0.4 |
| NH₃ [mol/L] | | 2.1 | 0.6 | 0 |
| diethylenetriamine [mol/L] | | 0 | 0 | 0.2 |
| NaOH [mol/L] | | 2.1 | 0.6 | 0.6 |
| dissolved oxygen amount [mg/L] | | 0.8 | 0.8 | 0.8 |
| oxygen concentration | in gas phase in each tank | 1 | 1 | 1 |
| [vol %] | around charge/discharge cell | 1 | 1 | 1 |

| | | | |
|---|---|---|---|
| charge/discharge cycle characteristic [%] | — | 99.6 | 95.0 |
| coulomb efficiency [%] | 97 | 100 | 100 |
| energy efficiency [%] | 71 | 75 | 70 |
| utilization rate of electrolyte [%] | 78 | 80 | 80 |
| electromotive force [V] | 1.2 | 1.2 | 1.2 |

### Embodiments 9-19

In the embodiments 9-19, as shown in Table 3, the charge/discharge test was performed in the same manner as the embodiment 7 except that the formulation of the titanium (IV)-citric acid complex aqueous solution was varied. The result thereof is shown in Table 3. “*1” in the column of “charge/discharge cycle characteristic” indicates that the charge/discharge cycle characteristic is 95% or more in the charging and discharging of the tenth cycle, and “*2” indicates that the charge/discharge cycle characteristic is 80% or more and 95% or less in the charging and discharging of the tenth cycle.

TABLE 3

| <titanium (IV)-citric acid | | Embodiment | | | | | | | | | | |
|---|---|---|---|---|---|---|---|---|---|---|---|---|
| complex aqueous solution> | | 9 | 10 | 11 | 12 | 13 | 14 | 15 | 16 | 17 | 18 | 19 |
| TiCl₄ [mol/L] | | 0.2 | 0.2 | 0.2 | 0.2 | 0.2 | 0.2 | 0.2 | 0.2 | 0.2 | 0.2 | 0.2 |
| citric acid [mol/L] | | 0.4 | 0.4 | 0.4 | 0.2 | 0.2 | 0.2 | 0.2 | 0.3 | 0.3 | 0.3 | 0.3 |
| NH₃ [mol/L] | | 0.2 | 0.4 | 0.6 | 0.2 | 0.3 | 0.4 | 0.5 | 0.2 | 0.4 | 0.6 | 0.8 |
| NaOH [mol/L] | | 1.0 | 0.8 | 0.6 | 0.6 | 0.5 | 0.4 | 0.4 | 0.7 | 0.5 | 0.3 | 0.1 |
| NaCl [mol/L] | | 0 | 0.2 | 0.4 | 0.6 | 0.7 | 0.8 | 0.9 | 0.5 | 0.6 | 0.7 | 0.8 |
| molar ratio of citric acid to Ti | | 2 | 2 | 2 | 1 | 1 | 1 | 1 | 1.5 | 1.5 | 1.5 | 1.5 |
| molar ratio of NH₃ to Ti | | 1 | 2 | 3 | 1 | 1.5 | 2 | 2.5 | 1 | 2 | 3 | 4 |
| molar ratio of NaOH to Ti | | 5 | 4 | 3 | 3 | 2.5 | 2 | 2 | 3.5 | 2.5 | 1.5 | 0.5 |
| dissolved oxygen amount | | 0.8 | 0.8 | 0.8 | 0.8 | 0.8 | 0.8 | 0.8 | 0.8 | 0.8 | 0.8 | 0.8 |
| [mg/L] | | | | | | | | | | | | |
| oxygen | in gas phase in | 1 | 1 | 1 | 1 | 1 | 1 | 1 | 1 | 1 | 1 | 1 |
| concentration | each tank | | | | | | | | | | | |
| [vol %] | around | 1 | 1 | 1 | 1 | 1 | 1 | 1 | 1 | 1 | 1 | 1 |
| | charge/discharge | | | | | | | | | | | |
| | cell | | | | | | | | | | | |

| | | | | | | | | | | | |
|---|---|---|---|---|---|---|---|---|---|---|---|
| charge/discharge cycle | *1 | *2 | *1 | *1 | *1 | *1 | *1 | *2 | *2 | *2 | *2 |
| characteristic [%] | | | | | | | | | | | |
| coulomb efficiency [%] | 99 | 99 | 100 | 76 | 75 | 77 | 99 | 82 | 73 | 91 | 83 |
| energy efficiency [%] | 67 | 67 | 75 | 50 | 43 | 46 | 60 | 50 | 50 | 60 | 50 |

### Embodiment 20

In the embodiment 20, the charge/discharge test was performed in the same manner as the embodiment 7, except that the diaphragm of the redox flow battery and the conditions of the charge/discharge test were varied. The diaphragm used in the embodiment 20 was made as follows. An unstretched ethylene-vinyl alcohol copolymer film (Product Name: Eval film EF-F50, thickness 50 μm, size 80×80 mm, specific gravity 1.19, produced by KURARAY Co., Ltd.), serving as the base material of the diaphragm, was sealed in a bag and then the interior of the bag was replaced with nitrogen. It was irradiated by an electron beam under the conditions of an accelerating voltage of 750 kV and an absorbed dose of 50 kGy. Thereafter, 20 mL of an aqueous solution containing 6 mass % of p-styrenesulfonic acid sodium (Product Name: Spinomer SS, produced by Tosoh Organic Chemical Co., Ltd.) was injected into the bag. Then, the bag was shaken for 2 hours in a thermostat chamber of 50° C. Thereby, an ion exchange membrane (diaphragm) formed by graft-polymerizing the p-styrenesulfonic acid sodium with the unstretched ethylene-vinyl alcohol copolymer film was obtained.

Subsequently, the ion exchange membrane was removed from the bag and washed with water or the like, and then dried. The graft ratio was calculated by substituting a pre-measured mass (W0) of the base material and a mass (W1) of the ion exchange membrane into the following equation (A).

Graft ratio (%)=100×(W1−W0)/W0 (A)

As a result of producing a plurality of ion exchange membranes, the graft ratio of the ion exchange membrane was in a range of 21-31%.

In the charge/discharge test of the embodiment 20, first, charging was performed for 60 minutes at a constant current. Then, the redox flow battery was discharged at a constant current with a discharge end voltage set to 0V. The constant current was set to 50 mA in the charging and discharging from the first cycle to the third cycle, and the constant current was set to 100 mA in the charging and discharging from the fourth cycle to the sixth cycle.

In the embodiment 20, the current efficiency, which is an evaluation item easily depending on the performance of the diaphragm, was calculated. The result thereof is shown in Table 4. The current efficiency is calculated by substituting an electricity amount (K) of charge of a predetermined cycle and an electricity amount (L) of discharge of the predetermined cycle into the following equation (6).

Current efficiency (%)=L/K×100 (6)

Regarding the current efficiency, an average value of the first to the third cycles and an average value of the fourth to the sixth cycles were calculated.

### Embodiment 21

In the embodiment 21, the charge/discharge test was performed in the same manner as the embodiment 20, except that the diaphragm of the redox flow battery was varied. The ion exchange membrane (diaphragm) was obtained in the same manner as the embodiment 20, except that the unstretched ethylene-vinyl alcohol copolymer film was changed to a biaxially stretched ethylene-vinyl alcohol copolymer film (Product Name: Eval film EF-XL15, thickness 15 μm, size 80×80 mm, specific gravity 1.23, produced by KURARAY Co., Ltd.) to serve as the diaphragm of the embodiment 21.

As a result of producing a plurality of ion exchange membranes following this procedure, the graft ratio of the ion exchange membrane was in a range of 28-30%. Same as the embodiment 20, the result of calculation of the current efficiency is shown in Table 4.

TABLE 4

| | | Embodiment | |
|---|---|---|---|
| | | 20 | 21 |
| current efficiency [%] | first cycle to third cycle (50 mA) | 94 | 100 |
| | fourth cycle to sixth cycle (100 mA) | 90 | 100 |

1. A redox flow battery, comprising:
a charge/discharge cell;
a first tank storing a positive-electrode electrolyte;
a second tank storing a negative-electrode electrolyte;
a first supply pipe supplying the positive-electrode electrolyte to the charge/discharge cell; and
a second supply pipe supplying the negative-electrode electrolyte to the charge/discharge cell,
wherein the positive-electrode electrolyte comprises an iron redox-based substance and an acid, and the acid in the positive-electrode electrolyte is a citric acid or a lactic acid;
the negative-electrode electrolyte is an electrolyte comprising a titanium redox-based substance and an acid, or an electrolyte comprising a copper redox-based substance and an amine;
the acid in the negative-electrode electrolyte is at least one of a citric acid and a lactic acid;
the amine is represented by a general formula (1): 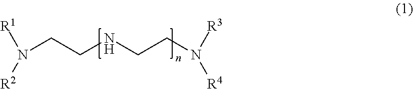
(wherein, n represents an integer of 0-4, and R¹, R², R³, and R⁴ independently represent a hydrogen atom, a methyl group, or an ethyl group); and
a dissolved oxygen amount in the negative-electrode electrolyte in the second tank is 1.5 mg/L or less.

2. The redox flow battery according to claim 1, comprising a case surrounding the charge/discharge cell, wherein an oxygen concentration in the case is 10 vol % or less.

3. The redox flow battery according to claim 1, wherein an oxygen concentration in a gas phase in the second tank is 1 vol % or less.

4. The redox flow battery according to claim 1, wherein a pH of the positive-electrode electrolyte and the negative-electrode electrolyte is in a range of 1 or more and 7 or less.
